(19) United States
(12) Patent Application Publication
(10) Pub. No.: US 2006/0198313 A1
(43) Pub. Date: Sep. 7, 2006

(54) Method and device for detecting and blocking unauthorized access

(75) Inventors: Tsutomu Kitamura, Minato-ku (JP); Toshiya Okabe, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/362,769

(22) Filed: Feb. 28, 2006

(30) Foreign Application Priority Data
Mar. 1, 2005 (JP) 2005-056221
Feb. 3, 2006 (JP) 2006-026872

(51) Int. Cl. H04J 1/16; H04L 12/26; H04L 1/00

(52) U.S. Cl. 370/241; 370/229

(57) ABSTRACT

A method for detecting an unauthorized or illicit traffic through a network comprises the steps of storing the expected values of a behavior for each type of the traffic in advance, separating individual traffics when performing communications through the network, measuring the behavior of the individually separated traffic, comparing the measured behavior with the expected values of the behavior, and determining the unauthorized or illicit traffic from the measured result.

### BACKGROUND OF THE INVENTION

1. Field of the Invention

The present invention relates to a method and device for detecting and blocking an unauthorized access through a network, and in particular, it relates to a method and device for detecting and blocking an unauthorized traffic, by categorizing the types of data traffics passing through a network for each characteristic.

2. Description of the Related Art

In recent years, an unauthorized access through the network has been rampant accompanied by the popularization of network environment such as the Internet, and a technology for detecting and blocking such an unauthorized access has come into the limelight. On the Internet, a TCP (Transmission Control Protocol), IP (Internet Protocol), and UDP (User Datagram Protocol) are used as a communication protocol, and data is transferred as a packet based on these protocols. In the header of the packet, there are stored a source IP address, source port number, destination IP address, destination port number, and the like. The packet is transmitted to the destination designated by the IP address based on the IP. The data packet is specified as to which application data it is by the port number defined by the TCP and UDP.

In order to detect and block the traffic related to the unauthorized access, the conventional unauthorized access detection device or unauthorized access blocking device determines the traffic, which includes bit patterns registered in advance regarding the port number, IP address or the like, as an unauthorized or illicit flow, and performs a processing of detecting and blocking the traffic of such unauthorized flow.

Japanese Patent Laid-Open Application No. 2004-38557 (JP, P2004-38557A) discloses an unauthorized access blocking system, in which the communication data received from an external network is compared with characteristic information which is set in advance, and the communication data only satisfying all pieces of characteristic information is determined as normal and transferred to a server.

Japanese Patent Laid-Open Application No. 2004-140618 (JP, P2004-140618) discloses a device for blocking an unauthorized access by packet filtering. In this device, a communication packet is compared with a detection pattern so as to find the number of agreements and non-agreements, and by collating this number to a criterion to determine a state transition, and the packet is transferred or discarded based on this state transition.

Japanese Patent Laid-Open Application No. 2003-218949 (JP, P2003-140618) proposes a method for detecting an unauthorized access by recording the source IP address, source port number, destination IP address and destination port number of the packet which is to be transmitted and received, analyzing the access pattern to the internal network from the outside, and comparing as to whether or not the analyzed pattern matches any of a plurality of types of unauthorized access patterns registered in advance. However, this method does not define the access pattern itself.

Japanese Patent Laid-Open Application No. 2004-356915 (JP, P2004-356915) discloses a method for detecting an unauthorized access and determining the type of the detected unauthorized access by storing the patterns of the variability with time of the amount of traffic or data packet generated by the unauthorized access for each unauthorized access type, and comparing the patterns of the variability with time of the actual traffic with the stored patterns. However, this method is difficult to detect new types of unauthorized access.

According to the above-described conventional methods for detecting the unauthorized access, there is a problem that the unauthorized access under an assumed port number of the TCP or UDP cannot be detected. In recent years, technologies of encryption or encapsulation of the traffic such as Any over HTTP and Mobile IP have been put into practice to improve security. However, in order to detect the unauthorized traffic in an encrypted traffic or encapsulated traffic, it is necessary to designate the bit patterns or access patterns of potential unauthorized traffics individually, and there arises a problem that the number of patterns to be designated or stored in advance increases.

Furthermore, since those disclosed in JP, P2004-140618A; JP, P2003-218949A; and JP, P2004-356915A are technologies for comparing the patterns based on the bygone unauthorized accesses and the present patterns, these technologies cannot detect a computer virus and a new malicious traffic transmitted by malicious user. Further, since the technology disclosed in JP, P2004-38557A necessitates the characteristic information of a normal communication data to be prepared in advance, there is a problem that the technology blocks even a new but legitimate traffic.

At all events, according to the above-described conventional technologies, since it is necessary for a maintenance person to designate the bit patterns or the access patterns in advance to detect an unauthorized traffic, maintenance becomes complicated, and it takes a lot of labor and time to cope with the appearance of new traffics.

### SUMMARY OF THE INVENTION

An object of the present invention is to provide a method and device for unauthorized traffic detection, in which an unauthorized traffic under an assumed port number can be detected, in which the unauthorized traffic can also be detected even from an encrypted or encapsulated traffic, and in which a new malicious traffic caused by a computer virus and the like can also be detected.

Another object of the present invention is to provide a method and device for unauthorized traffic detection, which can reduce the operation load of a maintenance person and can also flexibly cope with a new traffic.

Another object of the present invention is to provide a method and device for blocking or interrupting unauthorized traffics, which can detect an unauthorized traffic under an assumed port number, and can detect an unauthorized traffic even from an encrypted or encapsulated traffic, and can also detect a new malicious traffic caused by a computer virus and the like.

Another object of the present invention is to provide a method and device for blocking or interrupting unauthorized traffics, which can reduce the operation load of a maintenance person, and can also flexibly cope with a new traffic.

According to a first aspect of the present invention, a method for detecting an unauthorized access through a network is provided. The method comprises the steps of: storing expected value of behavior of each type of traffic in advance; separating individual traffics when performing communications through the network; measuring the behavior of the individually separated traffics; comparing the measured behavior with the expected value of behavior; and determining an unauthorized traffic from comparison result.

According to a second aspect of the present invention, a device for detecting an unauthorized access through a network is provided. The device comprises: reception means for receiving a traffic from said network; measurement means for measuring behavior of individually received traffic; and identification means for identifying whether or not the individual traffic is an unauthorized traffic according to measurement result by the measurement means.

According to a third aspect of the present invention, a device for detecting an unauthorized access through a network is provided. The device comprises: storage means for storing expected value of behavior for each type of traffic in advance; reception means for receiving traffics through the network, and separating the received traffics into individual traffics; measurement means for measuring behavior of the individually separated traffic; and comparison means for comparing the measured behavior with the expected value stored in the storage means, and determining an unauthorized traffic from the comparison result.

In the present invention, a traffic is typically constituted from a data packet by the TCP/IP. Such a packet is considered to show the behavior of a traffic defined by the packet length or its distribution, a packet arrival time interval or its distribution, and the like according to the application (or program) using the packet. Further, in the case of the TCP or UDP, a port number is used as an identifier of the application, and the port number and the application are associated.

Hence, in the present invention, the types of traffic are taken into consideration based on which application the traffic is generated by, and the behavior which the traffic would show is stored in the database in advance for each type of the traffic (that is, each application). As the behavior, for example, an average value of the packet length of the data packet constituting the traffic, dispersion value of the packet length, average value of the packet arrival time interval, and dispersion value of the packet arrival time interval are used. By using the average value and dispersion value of the packet length and the average value and dispersion value of the packet arrival time interval in this manner, the unauthorized traffic not detectable by monitoring the communication amount and packet amount alone can be detected.

In the above-described explanation, as the behavior of the traffic, the average value of the packet arrival time interval or dispersion value of the data packet which constitutes the traffic have been designated for use, not only the average value and the dispersion value, but other basic statistic value parameters such as standard variation can also be used. Further, in addition to the above-described parameters, the number of types of the packet length of the packet data which constitutes the traffic may be used as the behavior of the traffic. If the data packet is such that the TCP header is not encrypted, an appearance ratio of a PUSH packet in which a PUSH bit (that is, forced transfer bit) is set in a TCP flag may be used as the behavior of the traffic. By defining a plurality of data packets continuously transmitted as one burst, basic statistic value parameters such as the average value, dispersion value of the burst length and burst arrival time interval may be used as the behavior of the traffic.

According to the present invention, for example, in case there exists an unauthorized traffic accompanied by an assumed port number of the TCP or UDP, since the behavior of traffic under the assumed port number is different from the behavior of the traffic based on the original application, an expected value of the behavior obtained by retrieving the data base with the assumed port number does not match the behavior of the actual traffic, and thus it can be determined as an unauthorized traffic. With respect to an encrypted or capsulated traffic also, if the expected value of the behavior is stored in advance, similarly to the above-described case, the unauthorized traffic can be detected. Even in case a new malicious traffic emerges due to a computer virus, since such traffic does not have an expected value of the behavior registered, it can be determined as an unauthorized traffic.

In the present invention, means for registering or erasing an expected value of the behavior for each type of traffic for the storing means may be further provided, and the expected value of the behavior of the traffic can be registered or erased from the terminal and the like connected to a network, so that the operation load of a maintenance person can be reduced and a new traffic can be flexibly coped with.

Prior to executing an unauthorized traffic detecting processing by measuring the behavior of the traffic, the number of received packets per unit time in the individual traffic may be measured, and the traffic having the number of received packets per unit time which exceeds a threshold value may be considered as a suspicious traffic potentially unauthorized, thereby executing the unauthorized traffic detecting processing for the extracted suspicious traffic. By executing an unauthorized traffic detecting processing for a suspicious traffic, the unauthorized traffic detecting processing can be efficiently executed.

In the present invention, bit patterns regarding the port number, IP address, and the like may be registered in advance, and the individually separated traffics may be separated into an encrypted traffic and non-encrypted traffic, and for the encrypted traffic, the above-described encryption processing may be executed, and for the non-encrypted traffic, depending on whether or not the registered bit patterns are detected from the non-encrypted traffic, the unauthorized traffic detection may be executed. By so doing, even for the encrypted traffic unable to be coped with by the conventional method, the unauthorized detecting processing can be executed.

Further, in the present invention, in case a new traffic is detected, by totalizing the measurement results of the behavior of that traffic, means for generating an expected value of the new traffic may be further provided. By providing such means, the operation load of a maintenance person regarding the registration of an expected value of the behavior can be reduced.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a block diagram showing a structure of an unauthorized access blocking device according to a first embodiment of the present invention;

FIG. 2 is a flowchart showing the processing at the unauthorized accessing blocking device shown in FIG. 1;

FIG. 3 is a block diagram showing a structure of an unauthorized access blocking device according to a second embodiment of the present invention;

FIG. 4 is a block diagram showing a structure of an unauthorized access blocking device according to a third embodiment of the present invention;

FIG. 5 is a block diagram showing a structure of an unauthorized access blocking device according to a fourth embodiment of the present invention;

FIG. 6 is a block diagram showing a structure of an unauthorized access blocking device according to a fifth embodiment of the present invention;

FIG. 7 is a flowchart showing the processing at the unauthorized accessing blocking device shown in FIG. 6;

FIG. 8 is a block diagram showing a structure of an unauthorized access blocking device according to another embodiment of the present invention;

FIG. 9 is a flowchart showing the processing at the unauthorized access blocking device shown in FIG. 8; and

FIG. 10 is a block diagram showing a structure of an unauthorized access blocking device according to still another embodiment of the present invention.

### DETAILED DESCRIPTION OF THE PREFERRED EMBODIMENTS

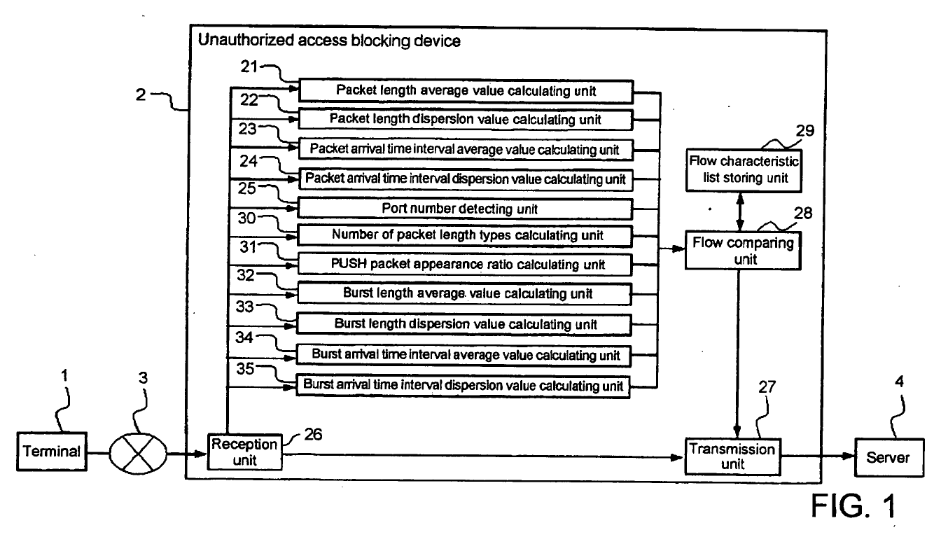

Unauthorized access blocking device 2 according to a first embodiment of the present invention shown in FIG. 1 detects an unauthorized access to server 4 from network 3, and blocks or interrupts such an unauthorized access so as not to reach server 4. Unauthorized access blocking device 2 is installed between network 3 and server 4. Network 3 is, for example, the Internet, and network 3 is further connected to terminal 1 also. While only one set of terminal is shown here in FIG. 1, needless to mention, network 3 is further connected to numerous terminals, servers, and other equipment, and these terminals, servers, and other equipment are potentially accessible to server 4, and these accesses may sometimes include unauthorized accesses. Here, unauthorized access blocking device 2 will be described as a device to detect and block an unauthorized access, but needless to mention, if attention is paid to a detecting function of the unauthorized access alone, unauthorized access blocking device 2 is allowed to be used as an unauthorized access detecting device.

Unauthorized access blocking device 2 comprises reception unit 26 for receiving a traffic from network 3; transmission unit 27 for transferring the received traffic to server 4; packet length average value calculating unit 21; packet length dispersion value calculating unit 22; packet arrival time interval average value calculating unit 23; packet arrival time interval dispersion value calculating unit 24; port number detecting unit 25; flow comparing unit 28; flow characteristic list storing unit 29; number of packet length types calculating unit 30; PUSH packet appearance ratio calculating unit 31; burst length average value calculating unit 32; burst length dispersion value calculating unit 33; burst arrival time interval average value calculating unit 34; and burst arrival time interval dispersion value calculating unit 35. Hereinafter, the structure of unauthorized access blocking device 2 will be described in detail.

Reception unit 26 receives a traffic addressed to server 4 from network 3, separates the traffic for each port number included in the header of the data packet which constitutes the traffic, transfers a copy of the traffic to packet length average value calculating unit 21, packet length dispersion value calculating unit 22, packet arrival time interval average value calculating unit 23, packet arrival time interval dispersion value calculating unit 24, port number detecting unit 25, number of packet length types calculating unit 30, PUSH packet appearance ratio calculating unit 31, burst length average value calculating unit 32, burst length dispersion value calculating unit 33, burst arrival time interval average value calculating unit 34, and burst arrival time interval dispersion value calculating unit 35, and at the same time, transfers the traffic to transmission unit 27. The traffic is, for example, transmitted from terminal 1.

Packet length average value calculating unit 21 receives the transferred traffic from reception unit 25, calculates an average value of the packet length of the data packet which constitutes the transferred traffic, and then notifies the calculated value to flow comparing unit 28. Similarly, packet length dispersion value calculating unit 22 receives the transferred traffic, calculates a dispersion value of the packet length of the data packet which constitutes the transferred traffic, and notifies the calculated value to flow comparing unit 28. Packet arrival time interval average value calculating unit 23 receives the transferred traffic, calculates an average value of the arrival time interval of the data packet constituting the transferred packet, and notifies the calculated value to flow comparing unit 28. Packet arrival time interval dispersion value calculating unit 24 receives the transferred packet, calculates a dispersion value of the arrival time interval of the data packet constituting the transferred packet, and notifies the calculated value to flow comparing unit 28. Port number detecting unit 25 receives the transferred packet, detects a port number of the data packet which constitutes the transferred traffic, and then notifies the detected value to flow comparing unit 28. In the above-described explanation, while the average value or the dispersion value regarding the packet length and the packet arrival time interval has been calculated, in place of the average value or dispersion value, basic statistic value parameters such as a standard deviation and median value may be calculated.

Number of packet length types calculating unit 30 receives the transferred packet, calculates the number of types of the packet length of the data packet constituting the transferred traffic, and notifies the calculated value to flow comparing unit 28. PUSH packet appearance ratio calculating unit 31 receives the transferred traffic, counts the number of PUSH packets from among the packet data constituting the transferred traffic, calculates a ratio of the number of PUSH packets to the number of all the received packets as a PUSH packet appearance ratio, and notifies the calculated value to flow comparing unit 28. The PUSH packet is a packet in which a push bit, that is, a forced transfer bit is set in the code bit region of a TCP header field as a TCP flag.

Burst length average value calculating unit 32 takes a group of the data packets continuously received from the transferred traffic as a burst, calculates an average value of the burst length of the burst, and notifies the calculated value to flow comparing unit 28. Burst length dispersion value calculating unit 33 calculates a dispersion value of the burst length of the burst, and notifies the calculated value to flow comparing unit 28. Burst arrival time interval average value 34 calculates an average value of the burst arrival time interval of the burst, and notifies the calculated value to flow comparing unit 28. Burst arrival time interval dispersion value 35 calculates a dispersion value of the arrival time interval of the burst, and notifies the calculated value to flow comparing unit 28. In the above-described explanation, while the average value or dispersion value regarding the burst length and the burst arrival time interval has been calculated, in place of the average value and dispersion value, basic statistic value parameters such as a standard deviation and a median value may be calculated.

Flow characteristic list storing unit 29 retains for every port number a list of expected values of the behavior defined by the port number, expected value of the packet length average value, expected value of the packet length dispersion value, expected value of the packet arrival time interval average value, expected value of the packet arrival time interval dispersion value, expected value of the number of packet length types, expected value of the PUSH packet appearance ratio, expected value of the burst length average value, expected value of the burst length dispersion value, expected value of burst arrival time interval average value, and expected value of the burst arrival time interval dispersion value. In the following explanation, the packet length average value, packet length dispersion value, packet arrival time interval average value, packet arrival time interval dispersion value, number of packet length types, PUSH packet appearance ratio, burst length average value, burst length dispersion value, burst arrival time interval average value, and burst arrival time interval dispersion value are put together and referred to as “behavior” of the traffic.

Flow comparing unit 28 compares the notified packet length average value, packet length dispersion value, packet arrival time interval average value, packet arrival time interval dispersion value, port number, number of packet length types, PUSH packet appearance ratio, burst length average value, burst length dispersion value, burst arrival time interval average value, and burst arrival time interval dispersion value with a list of expected values of the behavior retained in flow characteristic storing unit 29, and sends a transfer or abrogation (discard) instruction of the traffic to transmission unit 27. As will be described later, in case the notified contents are in the range of the expected values within the list, they are determined as legitimate traffics, and therefore, flow comparing unit 28 instructs transfer of the traffics, and otherwise, instructs abrogation of the traffics. Upon instruction of abrogation, flow comparing unit 28 notifies the content of the instruction to the maintenance person.

Transmission unit 27 performs the transfer to server 4 or abrogation of the traffic transferred from reception unit 26 according to the instruction of flow comparing unit 28.

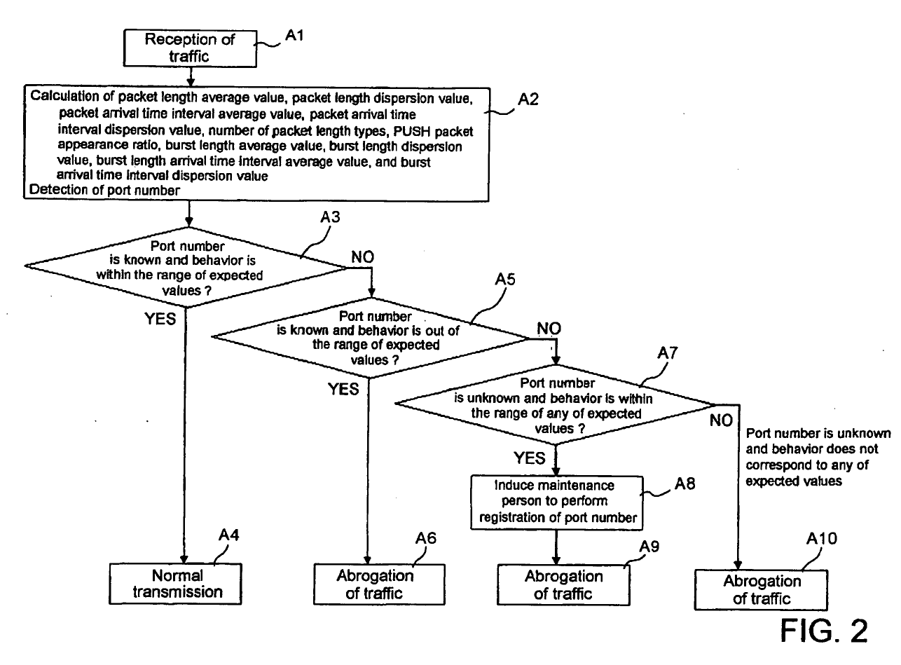

Next, the operation of this unauthorized access blocking device will be described with reference to FIG. 2.

In step A1, when reception unit 26 receives a traffic, reception unit 26 transfers a copy of each packet which constituting the received traffic to packet length average value calculating unit 21, packet length dispersion value calculating unit 22, packet arrival time interval average value calculating unit 23, packet arrival time interval dispersion value calculating unit 24, port number detecting unit 25, number of packet length types calculating unit 30, PUSH packet appearance ratio calculating unit 31, burst length average value calculating unit 32, burst length dispersion value calculating unit 33, burst arrival time interval average value calculating unit 34, and burst arrival time interval dispersion value calculating unit 35. As a result, in step A2, packet length average value calculating unit 21 calculates a packet length average value, packet length dispersion value calculating unit 22 calculates a packet length dispersion value, packet arrival time interval average value calculating unit 23 calculates a packet arrival time interval average value, packet arrival time interval dispersion value calculating-unit 24 calculates a packet arrival time interval dispersion value, number of packet length types calculating unit 30 calculates the number of packet length types, PUSH packet appearance ratio calculating unit 31 calculates a PUSH packet appearance ratio, burst length average value calculating unit 32 calculates a burst length average value, burst length dispersion value calculating unit 33 calculates a burst length dispersion value, burst arrival time interval average value 34 calculates a burst length arrival time interval average value, and burst arrival time interval dispersion value calculating unit 35 calculates a burst arrival time interval dispersion value. Further, port number detecting unit 25 detects a port number from the data packet of the received traffic. The detected port number and respective values calculated at each of calculating units 21 to 24 and 31 to 35 are notified to flow comparing unit 28.

Flow comparing unit 28, in step A3, compares the notified packet length average value, packet length dispersion value, packet arrival time interval average value, packet arrival time interval dispersion value, number of packet length types, PUSH packet appearance ratio, burst length average value, burst length dispersion value, burst arrival time interval average value, burst arrival time interval dispersion value, and port number with expected value of the behavior stored in flow characteristic storing unit 29, and determines whether or not the port number is known, and moreover, each notified value is in the range of the expected values corresponding to the port number.

In case the port number is known, and moreover, the behavior is in the range of the expected value, flow comparing unit 28 issues a transfer instruction to transmission unit 27, and transmission unit 27, in step A4, transfers the packet to server 4. In the meantime, in step A3, in case it is not “the port number is known, and moreover, the behavior is in the range of the expected value,” flow comparing unit 28, in step A5, determines whether or not “the port number is known but the behavior is out of the expected value.” In case the port number is known, but the behavior is out of the range of the expected value for that port number, flow comparing unit 28 takes the traffic as an unauthorized traffic, and issues an abrogation instruction to transmission unit 27, and transmission unit 27 abrogates or discards the packet in step A6.

In step A5, in case it is not “the port number is known but the behavior is out of the expected value,” though it can be said that the port number is unknown, in that case, flow comparing unit 28, in step A7, determines whether or not “the port number is unknown, and moreover, the behavior is in the range of any of the expected values registered in the list.” Here, if the port number is not known but the behavior itself is in the range of the expected values registered relating to any port number, there is a possibility that the traffic is not unauthorized but legitimate and that such port number is a type of the numbers not registered in the list. Hence, in case “the port number is unknown, and moreover, the behavior is in the range of any of the expected values registered in the list,” flow comparing unit 28, in step A8, induces the maintenance person to perform the registration of the port number and the expected value of the behavior corresponding to that port number, and issues an abrogation instruction of the traffic to transmission unit 27, and transmission unit 27 abrogates or discards the packet in step A9.

In case any of the above-described conditions is not met with, that is, in case the port number is not known, and moreover, the behavior does not correspond to any of the expected values, determining the traffic as unauthorized, flow comparing unit 28 issues an abrogation instruction of the traffic to transmission unit 27, and transmission unit 27 abrogates or discards the traffic in step A10.

Next, the advantages of the present embodiment will be described.

In the present embodiment, based on the port number and the behavior of the traffic defined by that port number, an unauthorized traffic is detected. Consequently, it is also possible to detect an unauthorized traffic under an assumed port number. Further, with respect to an encrypted or encapsulated traffic, it is also possible to detect it as unauthorized traffic in case the traffic differs from the expected behaviors.

In the above-described explanation, while the behavior of the traffic has been defined for the port number in the flow characteristic list, the behavior of the traffic can also be defined for each transmission terminal and reception terminal by using the source IP address, the destination IP address, and the like. The behavior of the traffic can also be defined for an identifier showing a terminal group such as a VLAN (virtual local area network) and subnet. The behavior can also be defined for an identifier, such as a value of a ToS (Type of Service) field within the IP header, which is used when traffics are grouped.

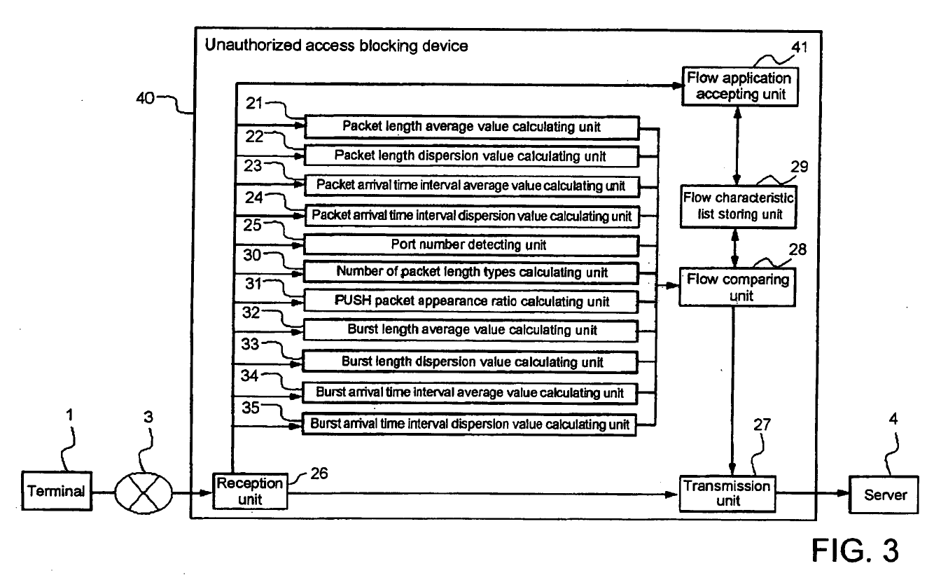

Next, an unauthorized access blocking device according to a second embodiment will be described. Unauthorized access blocking device 40 according to the second embodiment shown in FIG. 3 is the same as unauthorized access blocking device 2 shown in FIG. 1, but is different from unauthorized access blocking device 2 shown in FIG. 1 in that device 40 is provided with flow application accepting unit 41 for additionally registering the expected value of the behavior in the flow characteristic list by application from terminal 1.

Flow application accepting unit 41 is provided with a function of accepting from terminal 1 the application of the behavior expected value of the traffic. Upon accepting the application of the behavior expected value of the traffic, flow application accepting unit 41 registers the expected value in flow characteristic list storing unit 29. Flow application accepting unit 41 may be provided with a function of erasing the expected value according to a specific port number from the flow characteristic list.

In this unauthorized access blocking device 40, since the operation of other than flow application accepting unit 41 is the same as the operation of unauthorized access blocking device 2 of the first embodiment, the redundant description thereof will be not repeated here.

In unauthorized access blocking device 40 of the present embodiment, terminal 1 can apply for the behavior expected value, and based on that application, the behavior expected value is registered in flow characteristic list storing unit 29, and thus, it is possible to register a new traffic without interposition of the maintenance person. After the new traffic is registered in this manner, the new traffic is handled as a legitimate traffic, and the packet of that traffic is not abolished, and is transferred from transmission unit 27 to server 4. According to the present embodiment, by allowing the behavior expected value to be registered or erased from the terminal, the operation of the maintenance person regarding the registration of the new traffic can be reduced.

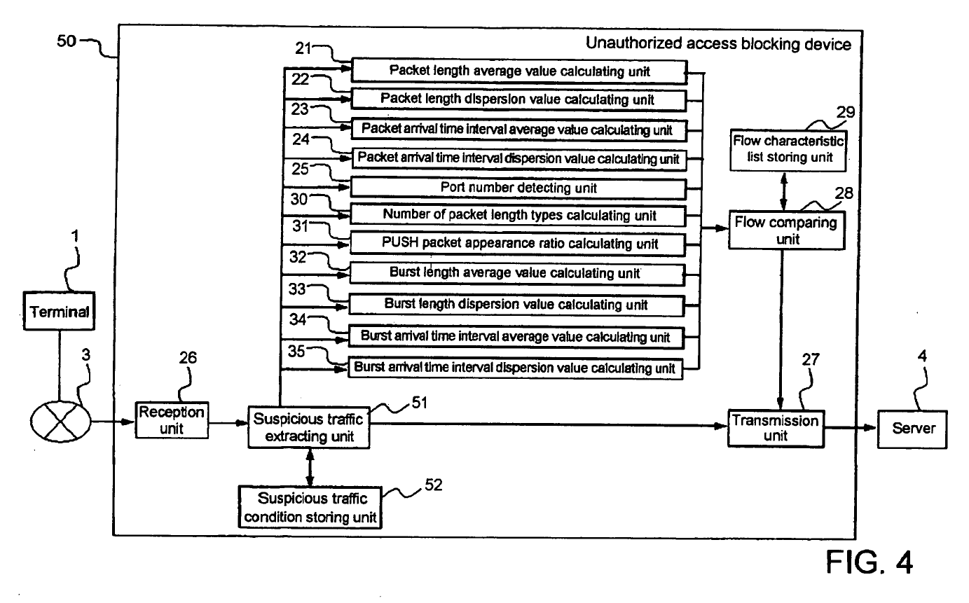

Next, an unauthorized access blocking device according to a third embodiment of the present invention will be described. Unauthorized access blocking device 50 of the third embodiment shown in FIG. 4 is the same as unauthorized access blocking device 2 shown in FIG. 1, but is configured such that, prior to executing an unauthorized traffic detecting processing by measuring the behavior of the traffic, the number of received packets is measured for each unit time in the individual traffic, and the traffic having the number of the received packets per unit time which exceeds a threshold value is extracted as a potentially unauthorized traffic. In the following explanation, the traffic potentially unauthorized is referred to as a suspicious traffic. Consequently, unauthorized access blocking device 50 of the third embodiment is different from unauthorized access blocking device 2 shown in FIG. 1 in that device 50 comprises suspicious traffic extracting unit 51 for transferring the suspicious traffic to unauthorized traffic detecting processing, and suspicious traffic condition storing unit 52 for storing suspicious traffic conditions. The suspicious traffic conditions are conditions used for extracting the suspicious traffic in suspicious traffic extracting unit 51.

Suspicious traffic extracting unit 51 is provided with a function of extracting only the suspicious traffic potentially unauthorized from among the received traffics, and transferring a copy of the extracted suspicious traffic to each of calculating units 21 to 24 and 30 to 35 and port number detecting unit 25 of the subsequent stage based on the suspicious traffic conditions stored in suspicious traffic condition storing unit 52. For example, suspicious traffic extracting unit 51 counts the number of received packets for each unit time of the individual traffic for the traffic transferred from reception unit 26, and takes the traffic in which the number of received packets for per unit time exceeds a threshold value retained in the suspicious traffic condition storing unit 52 as a suspicious traffic, and such a suspicious traffic is extracted. Here, while the suspicious traffic conditions retained in suspicious traffic condition storing unit 52 have been taken as the number of received packets for each unit time, other suspicious traffic conditions may be set.

In this unauthorized access blocking device 50, since the operation of other than suspicious traffic extracting unit 51 is the same as the operation of unauthorized access blocking device 2 of the first embodiment, the redundant description thereof will be not repeated here. In unauthorized access blocking device 50 of the third embodiment, the unauthorized traffic detecting processing by measuring the behavior of the traffic can be executed for the suspicious traffic, which is a potentially unauthorized traffic, extracted from among all the received traffics, and therefore, the unauthorized traffic detecting processing can be efficiently executed.

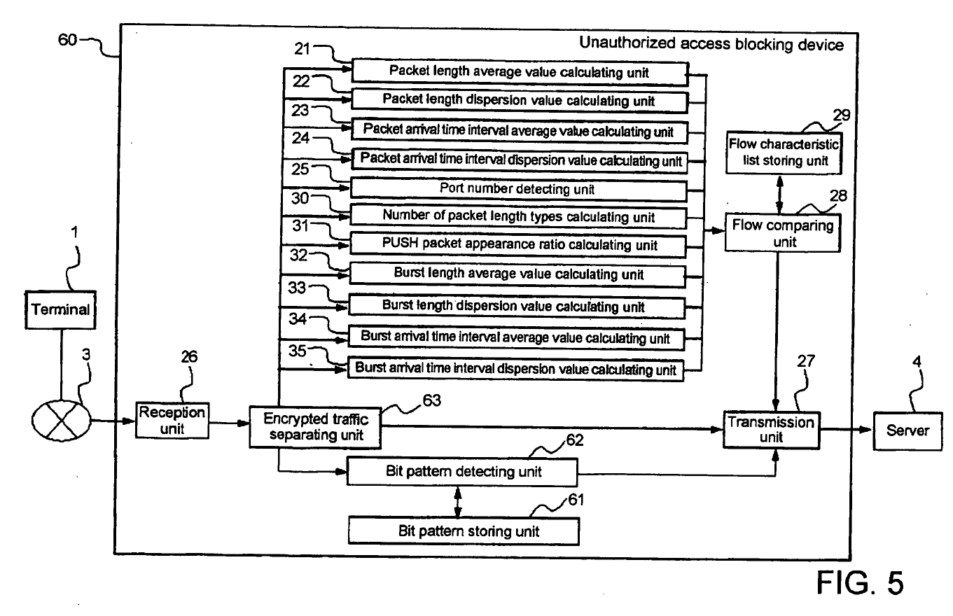

Next, an unauthorized access blocking device according to a fourth embodiment of the present invention will be described. Unauthorized access blocking device 60 of the fourth embodiment shown in FIG. 5 is the same as unauthorized access blocking device 2 shown in FIG. 1, but is different from unauthorized access blocking device 2 shown in FIG. 1 in that device 60 comprises bit pattern storing unit 61 for storing the bit patterns registered in advance relating to a port number and an IP address, and the like; bit pattern detecting unit 62 for detecting bit patterns registered in bit pattern storing unit 61 from the data packet transferred from reception unit 26; and encrypted traffic separating unit 63 for separating individually separated traffics into an encrypted traffic and a non-encrypted traffic.

Here, the bit patterns relating to the port number or IP address, and the like are the same as the bit patterns used by the conventional known method for packet filtering, and consequently, bit pattern storing unit 61 and bit pattern detecting unit 62 are the same as a functional block used for storing the bit patterns and a functional block used for detecting the bit patterns in a conventional packet filtering device, respectively. In other words, bit pattern detection unit 62, to specify the unauthorized traffic from the data portion of the data packet which constitutes the individual traffic, is provided with a function of detecting whether or not the bit patterns extracted from the data portion of the data packet correspond to the bit patterns registered in advance in bit pattern detecting unit 61.

Encrypted traffic separating unit 63 is provided with a function of transmitting the traffic received by reception unit 26 to transmission unit 27, and transmitting a copy of the encrypted traffic to each of calculating units 21 to 24 and 30 to 35 and port number detecting unit 25 to measure the behavior of the traffic for the encrypted traffic, and transferring the copy of the traffic to bit pattern detecting unit 62 for the non-encrypted traffic. Bit pattern detecting unit 62 executes an unauthorized traffic detecting processing by detection of the bit patterns for the non-encrypted traffic transferred from encrypted traffic separating unit 63.

In this unauthorized access blocking device 60, since the operation of other than bit pattern detecting unit 62 and encrypted traffic separating unit 63 is the same as the operation of the unauthorized access blocking device 2 of the first embodiment, the redundant description thereof will be not repeated here. In unauthorized access blocking device 60 of the fourth embodiment, the received traffics are separated into an encrypted traffic and a non-encrypted traffic, and for the non-encrypted traffic, an unauthorized traffic detecting processing by bit pattern detection which is a conventional technology is executed, and for the encrypted traffic, an unauthorized traffic detecting processing by measuring the behavior of the traffic is executed. In this manner, this unauthorized access blocking device 60 can execute the unauthorized traffic detecting processing for the encrypted traffic which is not capable with by the conventional technology.

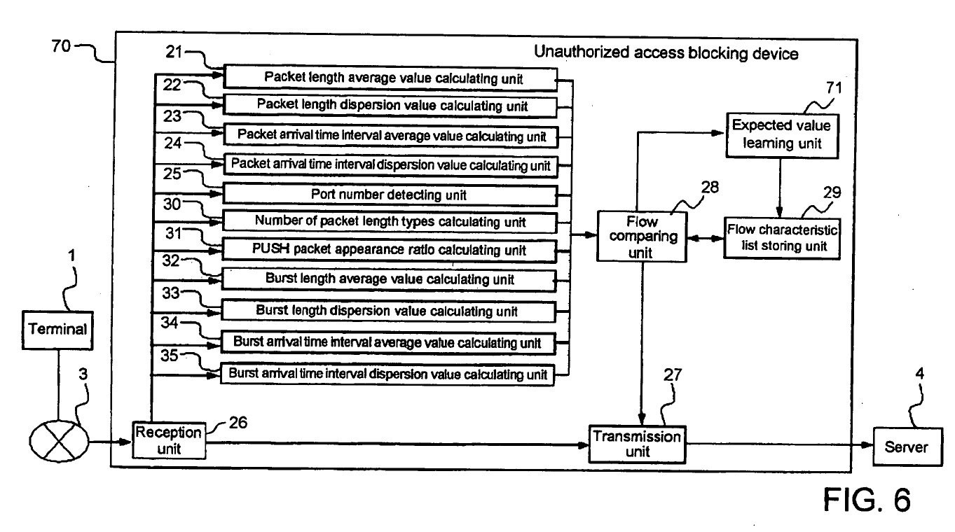

Next, an unauthorized access blocking device according to a fifth embodiment of the present invention will be described. Unauthorized access blocking device 70 of the fifth embodiment shown in FIG. 6 is the same as unauthorized access blocking device 2 shown in FIG. 1, but is different from unauthorized access blocking device 2 shown in FIG. 1 in that device 70 comprises expected value learning unit 71 for generating an expected value of the behavior of a new traffic from the result of measuring the behavior of the traffic in case the new traffic is detected. Flow comparing unit 28 is provided with a function of comparing the measured behavior with the expected value stored in flow characteristic list storing unit 29 so as to determine the unauthorized traffic, and at the same time, provided with a function of transferring the measured result of the behavior regarding a new traffic to expected value learning unit 71 in case the new traffic is detected.

To be more specific, flow comparing unit 28, in case the traffic is a new traffic in which “the port number is unknown, and moreover, the behavior does not match any of the expected values” as a result of executing the unauthorized access detecting processing by measuring the behavior of the traffic, notifies expected value learning unit 71 that a new traffic is detected, and transfers the behavior measuring result of the traffic transferred from each of calculating units 21 to 24 and 30 to 35 and port number detecting unit 25 to expected value learning unit 71. Expected value learning unit 71 is provided with a function of totalizing the behavior measurement result of the new traffic calculated in each of calculating units 21 to 24 and 30 to 35 and port number detecting unit 25 upon the notification of the detection of the new traffic from flow comparing unit 28, generating the behavior expected value of the new traffic, and storing the generated behavior expected value in flow characteristic list storing unit 29.

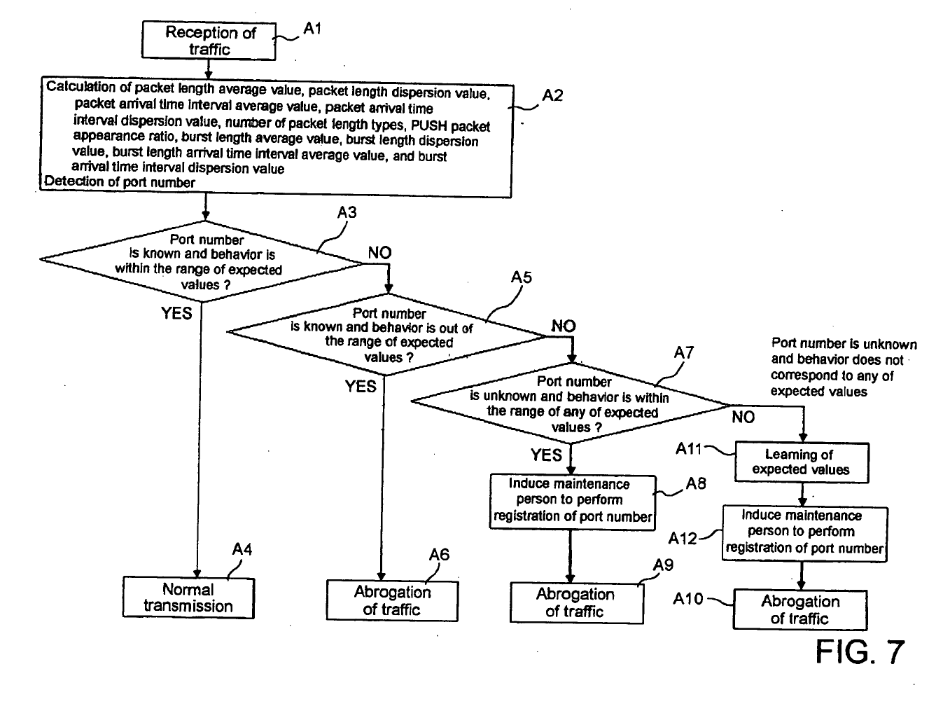

Since the operation of this unauthorized access blocking device 70 except the operation of flow comparing unit 28 at the time of detection of the new traffic and the operation of expected value learning unit 71 is equivalent to the operation of unauthorized access blocking device 2 of the first embodiment, the redundant description thereof will be not repeated here. Hereinafter, with reference to the flow chart of FIG. 7, the operation of this unauthorized access blocking device will be described.

Since each processing from step A1 to step A10 is the same as the processing (see FIG. 2) in unauthorized access blocking device 2 of the first embodiment. When determining that it is a new traffic in which “the port number is unknown and the behavior does not correspond to any of expected values” in step A7, flow comparing unit 28 notifies expected value learning unit 71 of a new traffic detection, and starts transferring the behavior measurement result of the traffic received from each of calculating units 21 to 24 and 30 to 35 and port number detecting unit 25 to expected value learning unit 71. Expected value learning unit 71, in step A 11, when notified of the new traffic detection from flow comparing unit 28, totalizes the behavior measurement result of the traffic transferred from flow comparing unit 28, and generates the behavior expected value of that new traffic. After generating the behavior expected value of the new traffic, expected value learning unit 71, in step A 12, performs notification to the maintenance person to induce him or her to register the port number and behavior expected value associated with that port number. When the registration of the port number and registration of the behavior expected value are made from the maintenance person, expected value learning unit 71 associates the behavior expected value with the port number and registers it in flow characteristic storing unit 29.

In unauthorized packet blocking device 70 of the present embodiment, by automatically generating the behavior expected value of the new traffic, the operation load of the maintenance person regarding the registration of the behavior expected value can be reduced.

In each embodiment as described above, as the behavior of the traffic, the port number, expected value of the packet length average value, expected value of the packet length dispersion value, expected value of the packet arrival time interval average value, expected value of the packet arrival time interval dispersion value, expected value of the number of packet length types, expected value of the PUSH packet appearance ratio, expected value of the burst length average value, expected value of the burst length dispersion value, burst arrival time interval average value, and expected value of the burst arrival time interval dispersion value are used. However, in the present invention, as the behavior of the traffic, it is needless to mention that other than those cited here can be used. Further, as occasion demands, any one or plural expected values selected from a group comprising: the port number, expected value of the packet length average value, expected value of the packet length dispersion value, expected value of the packet arrival time interval average value, expected value of the packet arrival time interval dispersion value, expected value of the number of packet length types, expected value of the PUSH packet appearance ratio, expected value of the burst length average value, expected value of the burst length dispersion value, burst arrival time interval average value, and expected value of the burst arrival time interval dispersion value may be used as the behavior of the traffic.

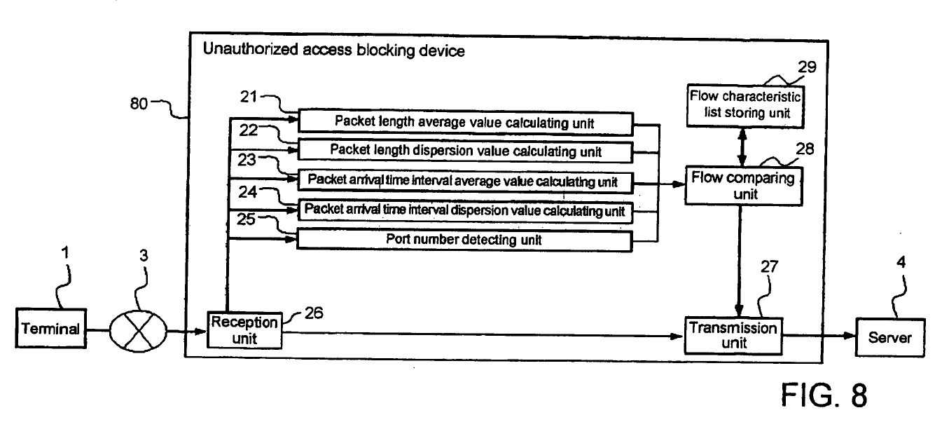

FIG. 8 shows an unauthorized access blocking device according to another embodiment of the present invention. Unauthorized access block device 80 shown in FIG. 8 is the same as unauthorized access interrupting device 2 of the first embodiment, but is different from unauthorized access blocking device 2 of the first embodiment in that, only the port number, expected value of the packet length average value, expected value of the packet length dispersion value, expected value of the arrival time interval average value, and expected value of the arrival time interval dispersion value are used as the behavior of the traffic. Consequently, unauthorized access blocking device 80 is not provided with the number of packet length types calculating unit, PUSH packet appearance ratio calculating unit, burst length average value calculating unit, burst length dispersion value calculating unit, burst arrival time interval average value calculating unit, and burst arrival time interval dispersion value calculating unit. In other words, unauthorized access blocking device 80 is provided with reception unit 26, transmission unit 27, packet length average value calculating unit 21, packet length dispersion value calculating unit 22, packet arrival time interval average value calculating unit 23, packet arrival time interval dispersion value calculating unit 24, port number detecting unit 25, flow comparing unit 28, and flow characteristic list storing unit 29.

In this unauthorized access blocking device 80, reception unit 26 receives the traffic addressed to server 4 from network 3, and separates the traffic for each port number included in the header of the data packet which constitutes the traffic, and transfers a copy of that traffic to packet length average value calculating unit 21, packet length dispersion value calculating unit 22, packet arrival time interval average value calculating unit 23, packet arrival time interval dispersion value calculating unit 24, and port number detecting unit 25, and transfers that traffic to transmission unit 27. Packet length average value calculating unit 21, packet length dispersion value calculating unit 22, packet arrival time interval average value calculating unit 23, packet arrival time interval dispersion value calculating unit 24, and port number detecting unit 25 execute the same processing as with the case of unauthorized access blocking device 2 of the first embodiment, respectively.

Flow characteristic storing unit 29 retains a list of behaviors defined by the port number, expected value of the packet length average value, expected value of the packet length dispersion value, expected value of the packet length arrival time interval average value, and expected value of the packet arrival time interval dispersion value for each port number. As described above, in this unauthorized access blocking device 80, the packet length average value, packet length dispersion value, arrival time interval average value, and arrival time interval dispersion value are put together and referred to as “behavior” of the traffic.

Flow comparing unit 28 compares the notified packet length average value, packet length dispersion value, packet arrival time interval average value, packet arrival time interval dispersion value, and port number with a list of the behavior expected values retained in flow characteristic list storing unit 29, and issues an instruction for transfer or abrogation of the traffic to transmission unit 27. Similarly with the case of the first embodiment, in case the notified content is in the range of the expected values within the list, it can be determined as a legitimate traffic, and therefore, flow comparing unit 28 instructs the transfer of the traffic, and otherwise, instructs the abrogation of the traffic. Upon instruction of abrogation, flow comparing unit 28 notifies the content of the instruction to the maintenance person.

Transmission unit 27 follows the instruction of flow comparing unit 28, and performs the transfer or abrogation of the traffic transferred from reception unit 26 to server 4.

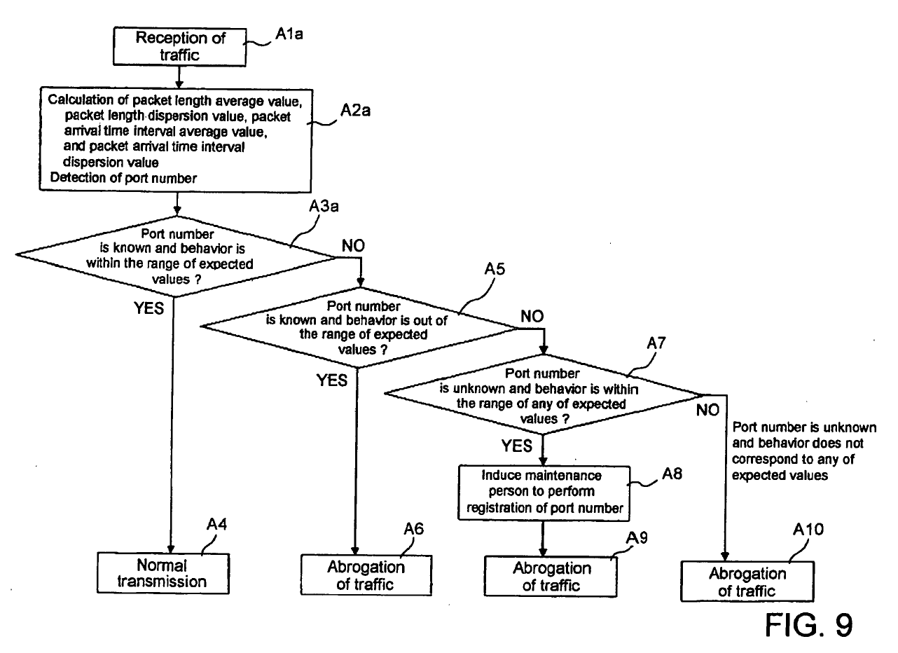

FIG. 9 is a flowchart to explain the operation of this unauthorized access blocking device 80. In step A1a, when reception unit 26 receives the traffic, reception unit 26 transfers a copy of each packet constituting the received traffic to packet length average value calculating unit 21, packet length dispersion value calculating unit 22, packet arrival time interval average value calculating unit 23, packet arrival time interval dispersion value calculating unit 24, and port number detecting unit 25. As a result, in step A2a, packet length average value calculating unit 21 calculates a packet length average value, packet length dispersion value calculating unit 22 calculates a packet length dispersion value, packet arrival time interval average value calculating unit 23 calculates a packet arrival time interval average value, and packet arrival time interval dispersion value calculating unit 24 calculates a packet arrival time interval dispersion value. Port number detecting unit 25 detects a port number from the data packet of the received traffic. The detected port number and each of the calculated average values and dispersion values are notified to flow comparing unit 28.

Flow comparing unit 28, in step A3a, compares the notified packet length average value, packet length dispersion value, packet arrival time interval average value, packet arrival time interval dispersion value, and port number with the behavior expected value stored in flow characteristic list storing unit 29, and determines whether or not the port number is known, and moreover, the average value or dispersion value is in the range of the expected values corresponding to that port number. The processing after executing step A3a, that is, the processing regarding steps A4 to A10 is the same as the case of the first embodiment, and therefore, the description thereof will be omitted.

In unauthorized access blocking device 80 shown in FIG. 8 also, based on the port number and the behavior of the traffic defined by that port number, an unauthorized traffic is detected. Consequently, it is possible also to detect an unauthorized traffic under the assumed port number. Further, with respect to the encrypted or encapsulated traffic also, if different from the expected behavior, it can be detected as an unauthorized traffic.

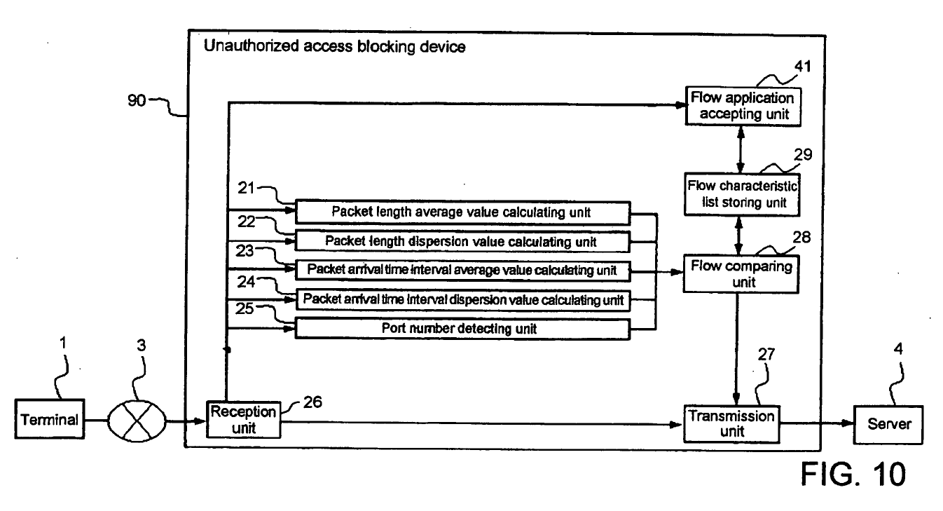

Unauthorized access blocking device 90 shown in FIG. 10 is the same as unauthorized access blocking device 80 shown in FIG. 8, but is different from unauthorized access blocking device 80 shown in FIG. 8 in that the device 90 comprises flow application accepting unit 41 for additionally registering the behavior expected value in the flow characteristic list by application from terminal 1.

Flow application accepting unit 41 is provided with a function of accepting from terminal 1 the application of the behavior expected value of the traffic. Upon accepting the application of the behavior expected value of the traffic, flow application accepting unit 41 registers the expected value in flow characteristic list storing unit 29. Flow application accepting unit 41 may be provided with a function of erasing the expected value according to a specific port number from the flow characteristic list.

In unauthorized access blocking device 90, since the operation of other than flow application accepting unit 41 is the same as the operation of unauthorized access blocking device 80, the redundant description thereof will be omitted. According to unauthorized access blocking device 90, since terminal 1 can apply for the expected value, it is possible to register a new traffic without interposition of the maintenance person.

Each of the unauthorized access blocking devices as described above can be realized also by allowing a computer program for realizing them to be read into a computer such as a server computer and the like and to be executed. As described above, the program for performing detection and blocking of the unauthorized access is read into a computer by a recording medium such as CD-ROM or through the network.

Such a computer, in general, comprises a CPU (central processing unit), hard disc drive for storing the program and data, main memory, input device such as a keyboard and mouse, display device such as a liquid crystal display, reading device for reading a recording medium such as CD-ROM, and communication interface for connection to network. This computer can be functioned as the above described unauthorized access blocking device by installing the recording medium stored with a program for performing detection and blocking of the unauthorized access in the reading device, and reading the program from the recording medium so as to store it into the hard disc drive so that the CPU executes the program stored in the hard disc drive or storing such a program into the hard disc drive through a network so that the CPU executes the program.

While preferred embodiments of the present invention have been described using specific terms, such description is for illustrative purposes only, and it is to be understood that changes and variations may be made without departing from the spirit or scope of the following claims.

What is claimed is:

1. A method for detecting an unauthorized traffic through a network, comprising the steps of:
storing an expected value of behavior in advance for each type of traffic;
separating individual traffics when performing communications through said network;
measuring the behavior of the individually separated traffics;
comparing the measured behavior with the expected value of behavior; and
determining an unauthorized traffic from comparison result.

2. The method according to claim 1, wherein said step of measuring comprises the step of measuring basic statistic value parameters regarding a packet length and a packet arrival time interval in a data packet which constitutes the traffic.

3. The method according to claim 2, wherein said basic statistic value parameters include an average value of the packet length, dispersion value of the packet length, average value of the packet arrival time interval, and dispersion value of the packet arrival time interval.

4. The method according to claim 1, wherein said step of measuring comprises the step of measuring number of types of a packet length of a data packet which constitutes the traffic.

5. The method according to claim 1, wherein said step of measuring comprises the step of measuring an appearance ratio of a packet with which a PUSH bit is set in a TCP plug.

6. The method according to claim 1, wherein said step of measuring comprises the steps of observing a plurality of data packet groups continuously transmitted as a burst, and measuring basic statistic value parameters regarding a burst length and a burst arrival time interval of the observed burst.

7. The method according to claim 6, wherein said basic statistic value parameters include an average value of the burst length, dispersion value of the burst length, average value of the burst arrival time interval, and dispersion value of the average value of the burst arrival time interval.

8. The method according to claim 1, wherein said step of separating comprises the step of separating said traffics by using an identifier of an application included in a data packet which constitutes the traffic.

9. The method according to claim 8, wherein a type of the traffic is determined based on the identifier of the application.

10. The method according to claim 8, wherein the identifier of said application is a port number.

11. The method according to claim 1, wherein said step of separating comprises the step of separating said traffics by using an identifier of transmission terminal and receiving terminal included in the data packet which constitutes the traffic.

12. The method according to claim 1, wherein said step of separating comprising the step of separating said traffics by using an identifier of a group of traffics or terminals, said identifier being included in a data packet which constitutes the traffic.

13. The method according to claim 1, further comprising the step of registering and/or erasing the expected value of the behavior for each type of the traffic from an external terminal before and after.

14. The method according to claim 1, wherein number of received packets per unit time in the individual traffic is measured, and a traffic having the number of received packets per unit time which exceeds a threshold value is taken as a suspicious traffic potentially unauthorized, and for the suspicious traffic, said step of measuring, said step of comparing and said step of determining are executed.

15. The method according to claim 1, further comprising the steps of:
separating said individually separated traffics into an encrypted traffic and a non-encrypted traffic;
executing said step of measuring, said step of comparing, and said step of determining for said encrypted traffic; and
performing an unauthorized access detection by detecting a bit pattern registered in advance from the non-encrypted traffic.

16. The method according to claim 1, further comprising the step of generating the expected value of behavior of a new traffic by totalizing the result of measurement of its behavior in case the new traffic is detected.

17. A device for detecting an unauthorized traffic through a network, comprising:
reception means for receiving a traffic from said network;
measurement means for measuring behavior of individually received traffic; and
identification means for identifying whether or not the individual traffic is an unauthorized traffic according to measurement result by said measurement means.

18. A device for detecting an unauthorized traffic through a network, comprising:
storage means for storing expected value of behavior for each type of traffic in advance;
reception means for receiving traffics through said network, and separating the received traffics into individual traffics;
measurement means for measuring behavior of the individually separated traffic; and
comparison means for comparing the measured behavior with the expected value stored in said storage means, and determining an unauthorized traffic from the comparison result.

19. The device according to claim 18, wherein said measurement means measures basic statistic value parameters regarding a packet length and a packet arrival time interval in a data packet which constitutes the individual traffic.

20. The device according to claim 19, wherein said basic statistic value parameters include an average value of the packet length, dispersion value of the packet length, average value of the packet arrival time interval, and dispersion value of the packet arrival time interval.

21. The device according to claim 18, wherein said measurement means measures number of packet length types of a data packet which constitutes the individual traffic.

22. The device according to claim 18, wherein said measurement means measures an appearance rate of a packet with which a PUSH bit is set in a TCP flag from among data packets which constitute the individual traffic.

23. The device according to claim 18, wherein said measuring means observes a plurality data packet groups continuously transmitted as a burst, and measures basic statistics value parameters regarding a packet length and a packet arrival time interval of the observed burst.

24. The device according to claim 23, wherein said basic statistics value parameters include an average value of the burst length, dispersion value of the burst length, average value of the burst arrival time interval, and dispersion value of the average value of the burst arrival time interval.

25. The device according to claim 18, wherein said reception means separates the traffic by using an identifier of an application included in a data packet which constitutes the traffic.

26. The device according to claim 25, wherein a type of the traffic is determined based on the identifier of the application.

27. The device according to claim 25, wherein the identifier of said application is a port number.

28. The device according to claim 18, further comprising means for registering and/or erasing the expected value of the behavior for each type of the traffic for said storage means.

29. The device according to claim 18, wherein number of received packets per unit time in the individual traffic is measured, and the traffic having the number of received packets per unit time which exceeds a threshold value is taken as a suspicious traffic potentially unauthorized, and the device further comprises means for transferring the suspicious traffic to said measurement means.

30. The device according to claim 20, further comprising:
bit pattern detection means for detecting a bit pattern registered in advance, and
means for separating said individually separated traffics into an encrypted traffic and a non-encrypted traffic, transferring said encrypted traffic to said measurement means, and transferring said non-encrypted traffic to said bit pattern detection means.

31. The device according to claim 18, further comprising means for generating the expected value of behavior of a new traffic by totalizing the result of measurement of its behavior in case the new traffic is detected.

32. A method for blocking an unauthorized access through a network, comprising the steps of:
determining whether or not an individual traffic is unauthorized by executing the unauthorized access detecting method according to claim 1, and
blocking an traffic which is determined as unauthorized.

33. A device for blocking an unauthorized traffic through a network, comprising:
a device for detecting an unauthorized access according to claim 17; and
means for blocking an traffic determined as unauthorized by said device for detecting an unauthorized access.

34. A device for blocking an unauthorized traffic through a network, comprising:
a device for detecting an unauthorized access according to claim 18; and
means for blocking an traffic determined as unauthorized by said device for detecting an unauthorized access.

35. A program allowing a computer to be functioned as:
storage means for storing expected value of behavior for each type of a traffic in advance:
reception means for receiving traffics through said network and separating them into individual traffic;
measurement means for measuring behavior of the individually separated traffic; and
comparison means for comparing the measured behavior with the expected value stored in said storage means, and determining an unauthorized traffic from the comparison result.
